(19) United States
(12) Patent Application Publication
(10) Pub. No.: US 2025/0035803 A1
(43) Pub. Date: Jan. 30, 2025

(54) MICROSEISMIC WAVEFORM PROCESSING LEVERAGING MACHINE LEARNING

(71) Applicant: Schlumberger Technology Corporation, Sugar Land, TX (US)

(72) Inventors: Lalitha Venkataramanan, Cambridge, MA (US); Joel Herve Le Calvez, Sugar Land, TX (US)

(21) Appl. No.: 18/782,088

(22) Filed: Jul. 24, 2024

Related U.S. Application Data
(60) Provisional application No. 63/515,162, filed on Jul. 24, 2023.

(51) Int. Cl. G01V 1/28

(52) U.S. Cl. CPC G01V 1/288; G01V 1/282; G01V 2210/32

(57) ABSTRACT

Embodiments presented provide for a method for performing waveform processing. In one embodiment, a synthetic dictionary is created and then, using a machine learning process, data is processed to produce a result.

### CROSS-REFERENCE TO RELATED APPLICATIONS

The current application claims priority to U.S. Provisional Patent Application 63/515,162, filed Jul. 24, 2023, the entirety of which is incorporated by reference.

### FIELD OF THE DISCLOSURE

Aspects of the disclosure relate to reservoir imaging. More specifically, aspects of the disclosure relate to providing an accelerated delivery of reservoir images compared to conventional imaging services. The aspects relate to microseismic waveform processing with efforts to denoise field data.

### BACKGROUND

As time progresses, the availability of large hydrocarbon fields diminishes. Oil field service companies are called upon to develop small and more complex hydrocarbon fields in order to meet the needs of industry. These smaller fields are more technically complex, and their development may cost too much money to develop economically. It is therefore important for oil field companies to be able to obtain accurate data that can be evaluated in a timely and efficient manner.

Reservoir imaging is a process that can be used in a multitude of hydrocarbon recovery operations. Reservoir imaging can allow for operators to determine the lateral extent of a hydrocarbon reserve as well as the reserve's depth. Depending upon the results obtained, a single or multiple wellbores may be drilled in order to obtain the hydrocarbons. Other factors of well construction may also be guided by reservoir imaging. Such features may be wellbore sizing, inclination, need for artificial lift and wellbore depth.

While obtaining data may be accomplished from various systems, the data that is obtained may be corrupted or not indicative of actual geological structures. Accurate evaluation of data; therefore, can be an important task for engineering staff. Conventional systems that are used to evaluate such data are cumbersome. Typically, a highly skilled and experienced engineer or scientist is needed to evaluate the data and determine which data is representative or not representative of geological structures. Many times, the data that is present will contain noise that may be generated by several factors. Noise, in fact, can be a major contributor to inaccurate results. As a result of the significant problem that exists with noisy data, special provisions are created to clean data that is used for analysis. Despite these efforts, conventional techniques to denoise data are limited in their effectiveness.

In the field of monitoring (oil/gas/geothermal/carbon capture underground storage/etc.), operators are interested in different aspects of the site (i.e., structural geology, etc.) and reservoir understanding (e.g., attenuation, etc.). Operators are also interested in deformation monitoring related to anthropogenic activities (e.g., stimulation, injection, extraction, etc.) as well as natural causes (e.g., faulting, fracturing, subsidence, etc.). Such interests are critical to not only understanding the structures present, but also the overall economic value of a site. In further activities, physical properties of the reservoir, such as pressure as well as the ability to recharge pressure may be evaluated. Conventional apparatus and evaluation methods are extremely limited. At the start of potential recovery projects, the amount of information available to make critical decisions on whether to develop a hydrocarbon field is limited. Due to this lack of information, engineers may be conservative in their decisions to develop marginal fields. If these marginal fields do not prove to be economically viable at a specific price point, decisions to not develop marginal fields may be made. Variations in the price of oil; therefore, can play a significant role in whether a wellsite gets developed.

In the monitoring business in general, speed of delivery of the final product is one of the key business differentiators. An example of this trend is found with weather nowcasting, earthquake and tsunami early warning. In earthquake early warning systems, for example, the magnitude of earthquake and its hypocenter are quickly estimated from limited datasets, and the decisions of shutting down any public domain services are decided in real time. In oil/gas geophysics; however, real-time service is provided only for a limited set of products.

There is a need to increase the speed of delivery of analysis of geological features used in the hydrocarbon recovery industry.

There is a need to provide an apparatus as well as methods that are easy to operate for those proposed analysis described above.

There is a further need to provide apparatus and methods that do not have the drawbacks discussed above, namely excessive time lapse after initial sampling.

There is a further need to provide for apparatus and methods that do not require specialized engineering staff that have extensive experience in various types of geological analysis.

There is a further need to provide apparatus and methods that can account for variations in data and allow for evaluation of geological data in a safe and efficient manner.

There is a still further need to reduce economic costs associated with operations and apparatus described above with conventional tools and methods.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for processing data is disclosed. The method may comprise obtaining data for processing training and taking the obtained data for processing training and making a dictionary from the obtained data. The method may also comprise training a machine learning algorithm with the dictionary and obtaining field data related to a geological environment. The method may also comprise denoising the field data, wherein the machine learning algorithm is used to perform the denoising and determining a probability function of the denoised field data to determine a probability density function. The method may also comprise using the probability function to determine a presence of an event within the obtained data and at least one of displaying and storing the probability function in a non-volatile memory system.

In another example embodiment, a computer readable storage medium is disclosed. The medium may have data stored therein representing an executable by a computer, the software may include instructions to perform steps of obtaining data for processing training, and taking the obtained data for processing training and making a dictionary from the obtained data. The method may further comprise training a machine learning algorithm with the dictionary. The method may further comprise obtaining field data related to a geological environment and denoising the field data, wherein the machine learning is used to perform the denoising and determining a probability function of the denoised field data to determine a probability density function. The method may also comprise using the probability function to determine a presence of an event within the obtained data.

In another example, a method for processing microseismic waveform field data is disclosed. The method may comprise obtaining geological training data. The method may further comprise making a dictionary from the obtained geological training data. The method may further comprise training a machine learning algorithm with the dictionary. The method may further comprise obtaining the geological microseismic waveform field data. The method may further comprise denoising the geological microseismic waveform field data with the machine learning algorithm to produce denoised field data. The method may further comprise using the probability function to determine a presence of an event within the geological microseismic waveform field data.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are therefore not be considered limiting of its scope, for the disclosure may admit to other equally effective embodiments.

FIG. 1 is a conventional time-series data corresponding to a microseismic event.

FIG. 2 is a dictionary of time-series events with associated labels.

FIG. 3 is a encoder-decoder to (1) reduce data dimensionality and (2) reduce noise and outliers.

FIG. 4 illustrates the use of a classifier to determine the probability density function of events.

FIG. 5 is a flow chart of a method of one example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers, and/or sections, these elements, components, regions, layers, and/or sections should not be limited by these terms. These terms may be only used to distinguish one element, components, region, layer, or section from another region, layer, or section. Terms such as “first”, “second”, and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on,” “engaged to”, “connected to”, or “coupled to”, another element or layer, it may be directly on, engaged, connected, coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure relate to microseismic analysis that is typically performed in relation to development of hydrocarbon reserves. In embodiments, monitoring may be accomplished at different phases of a hydrocarbon recovery project. The monitoring described herein, in non-limiting embodiments, is performed relying on fiber optical data as well as traditional 1C/3C/4C sensors. Since changes in formation property can be seen as changes of a wavefield around the borehole, one or more sources are placed at the surface. These sources are used to beam waves into the geological stratum. The sensors are deployed into the downhole through various methods. The sensors then acquire data pertaining to the wavefield propagating along the borehole. Optical fiber-acquired datasets are large due to the density of the sampling and the length of the receiver array(s). Each record represents hundreds of mega-byte size as seismic data file.

When it comes to microseismic monitoring, aspects of the present disclosure are to determine hypocenters, source parameters (e.g., magnitude), and when possible, moment tensor(s) (i.e., failure mechanism at the hypocenter) as quickly as possible with as little uncertainty as possible. Through the evaluation and identification of these aspects, engineers may correctly evaluate localized conditions around a wellbore.

In embodiments, waveform-based machine learning approaches are used to:
(1) Denoise microseismic events,
(2) Compress time-series data relating to these events,
(3) Detect a presence/absence of the microseismic event, and
(4) Detect the number of microseismic events.

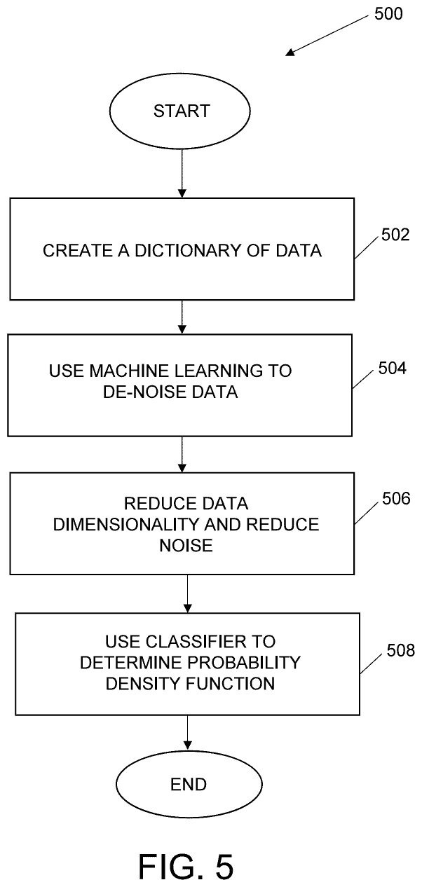

The methods described herein enable real-time delivery and interpretation of an extremely large dataset. One example method embodiment is disclosed in FIG. 5. Other embodiments are possible and the method 500 described in FIG. 5 should not be considered limiting.

As illustrated in FIG. 5, at 502, a dictionary of synthetic data is created. Several methods may be used to generate synthetic data. Ultimately, as presented herein, a method is used that generates seismograms/seismographs similar to the one to be processed in real-time so that machine learning (ML) may be applied. As will be understood, although described as using synthetic data, other data may be used. In one such embodiment, actual field data from a nearby well may also be used for training purposes.

Input required for synthetic data generation include, in one non-limiting example:
an Event location,
a Receiver location,
a Velocity model,
an Attenuation model,
an Event magnitude, and
a Noise background.
   Other models and data may also be included as inputs.

The outcome of the computations of the inputs are seismograms waveforms/seismograms (images). From a synthetic generation point of view, waveforms are beneficial for overall use.

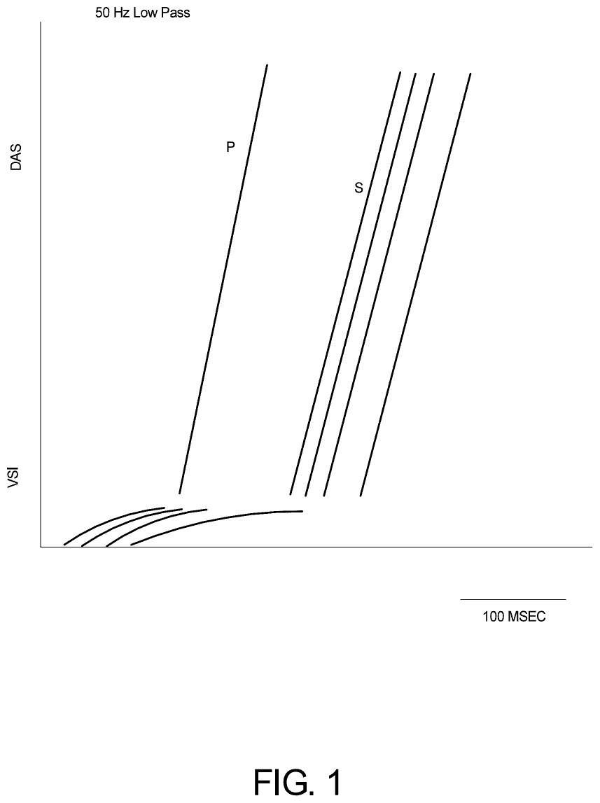

A typical time-series data set obtained from an event is shown in FIG. 1. As will be understood, the event illustrated in FIG. 1 is provided as a non-limiting example embodiment.

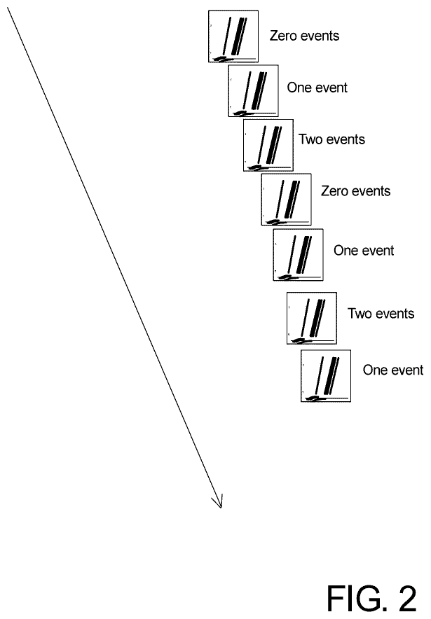

In one aspect of the disclosure, a dictionary of time-series data is produced. In embodiments a single and/or multiple events for different source and receiver locations, velocity and attenuation models, and event magnitude are shown. Thus, the dictionary consists of time-series data with associated labels (zero/one/two/three, . . . events) as shown in FIG. 2.

Referring to FIG. 5, at 504, the method 500 continues with the use of machine learning model to denoise the data obtained at 502, remove outlier data and provide data compression.

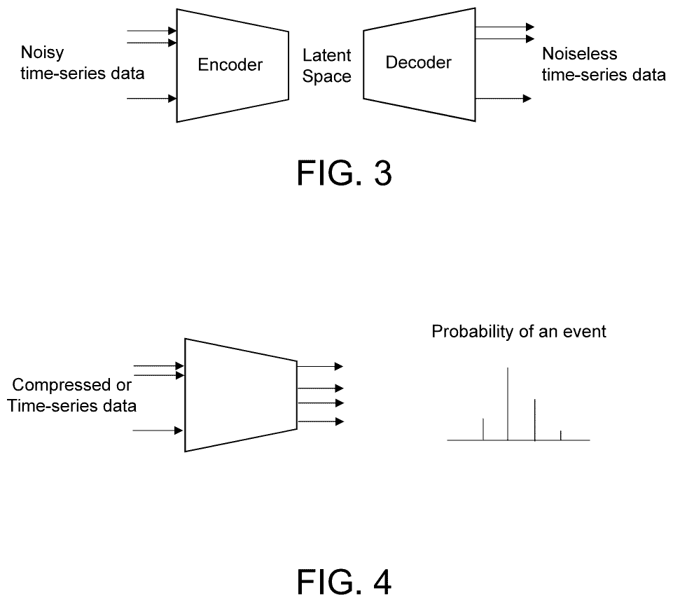

In one example embodiment, the use of a de-nosing algorithm, at 504 is used to remove outliers and denoise the data. For example, the machine learning architecture may be a de-noising encoder-decoder as shown in FIG. 3 and illustrated in 506. The data incorporates corrupted data (“noise”), with statistics representing noise from the sensors and the environment. In embodiments, this noise is assumed to be white and Gaussian in nature.

The noisy time-windowed data is fed into the input of the encoder. After processing at the encoder, a noise-less (clean) data is produced as an output. In embodiments, the encoder and decoder are simultaneously trained so that the input noisy data is projected into a latent space, whose size is much smaller than the size of the input. Knowledge of the physics involved is used to help guide the choice of the dimensionality of the latent space. The dimensionality of the latent space is typically much smaller than the size of the input. This, in turn, leads to data compression. The decoder projects data back from the latent space into time-series data that closely approximates the noiseless data. Thus, the encoder-decoder combination reduces noise, removes outliers as well as compresses data into a few latent space variables. As will be understood, method step 506 may be combined with method step 504 or may be a separate step as illustrated in FIG. 5.

In some embodiments, the encoder may be used/included with a processor. When the encoder is implemented in a processor downhole, the data can be compressed downhole and transmitted to the surface. In some embodiments, the decoder may be used in surface software. When the decoder is implemented on surface software, the compressed data is projected back into time-series data with a reduced level of noise and without outliers.

The dictionary may be updated over time. In these instances, the dictionary will comprise time-series data as well as corresponding compressed data and associated labels.

The method 500 may continue at 508 by using machine learning to detect events and identify the number of events. Differing machine learning algorithms and techniques may be used in this step.

In embodiments, the compressed data as well as associated labels are used in a supervised-learning format to train a classifier. In embodiments, the classifier may be based on logistic regression to detect an event from a non-event. In other embodiments, the classifier may be based on decision trees, support vector machines, k-nearest neighbor, or neural networks. The output of the classifier is a probability density function that determines the likelihood that the data has zero/one/two/multiple events, as shown in FIG. 4.

Aspects of the disclosure provide for increased speed of delivery for analysis of geological features used in the hydrocarbon recovery industry. This increased speed can be provided at both initial evaluation and upon the retention of further information from field activities. In such instances, the methods and apparatus greatly enhance the overall evaluation of a wellsite.

Aspects of the disclosure provide an apparatus and methods that are easy to operate for those proposed analysis. Specialized training or using highly skilled engineers or scientists are not necessary.

Aspects of the disclosure provide for immediate feedback of results to operators. In embodiments, excessive time lapse after initial sampling is precluded and efficiency is increased for hydrocarbon recovery operations.

Aspects provide for apparatus and methods that do not require specialized engineering staff that have extensive experience in various types of geological analysis. The use of less experienced staff allows for greater economy of operations and availability of services for analysis. Analysis may be conducted on a worldwide scale rather than only in areas where specifically trained individuals are located.

Aspects provide for apparatus and methods that can account for variations in data and allow for evaluation of geological data in a safe and efficient manner. To this end, calculation capability may be repeated, as needed for projects with little economic expenditure. Moreover, lessons learned from previous calculations may be incorporated into future calculations to achieve better results. If calculations failed to show critical features of a geological location that suffered a safety related event, then alterations in future calculations may be achieved through compensating measurements. Factors of safety may be increased such that, over time, safety implications on calculations may be minimized or eliminated, while maintaining sufficient safety for workers and the environment.

Aspects of the disclosure also reduce economic costs associated with operations and apparatus described above with conventional tools and methods and allow marginal hydrocarbon reserves to be developed. As time moves forward and the need for hydrocarbons continues, development of such marginal reserves increases. Processing of such microseismic waveforms becomes more paramount.

The terms “tangible” and “non-transitory”, as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may be transmitted by transmission media or signals such as electrical, electromagnetic, or digital signals, which may be conveyed via a communication medium such as a network and/or wireless link.

Embodiments of the disclosure, as described above, increase the speed of delivery of analysis of geological features used in the hydrocarbon recovery industry.

Embodiments of the disclosure, as described above, do not have the drawbacks of conventional analysis, namely excessive time lapse after initial sampling.

Embodiments of the disclosure, as described above, do not require specialized engineering staff that have extensive experience in various types of geological analysis.

Example embodiments of the claims are described next. The example embodiments should not be considered limiting. In one example embodiment, a method for processing data is disclosed. The method may comprise obtaining data for processing training and taking the obtained data for processing training and making a dictionary from the obtained data. The method may also comprise training a machine learning algorithm with the dictionary and obtaining field data related to a geological environment. The method may also comprise denoising the field data, wherein a machine learning algorithm is used to perform the denoising and determining a probability function of the denoised field data to determine a probability density function. The method may also comprise using the probability function to determine a presence of an event within the obtained data and at least one of displaying and storing the probability function in a non-volatile memory system.

In another example embodiment, the method may be performed wherein the event is a microseismic event.

In another example embodiment, the method may be performed wherein the field data is obtained from sensors on at least one fiber optic cable.

In another example embodiment, the method may further comprise reducing a dimensionality of the denoised data.

In another example embodiment, the method may be performed wherein the denoising of the obtained data is performed by a classifier.

In another example embodiment, the method may be performed wherein the classifier used a logistic regression to detect an event from a non-event.

In another example embodiment, the method may further comprise compressing time-series data after the denoising.

In another example embodiment, the method may be performed wherein one of a decision tree, support vector machine, k-nearest neighbor, and neural network is used.

In another example embodiment, the method may be performed wherein the method is performed in a downhole environment.

In another example embodiment, the method may further comprise transmitting the probability function to a surface environment.

In another example embodiment, the method may be performed wherein the denoising of the field data removes data determined to be noise from the field data.

In another example embodiment, the method may further comprise compressing the denoised field data after the denoising the field data.

In another example embodiment, the method may further comprise transmitting the compressed field data.

In another example embodiment, a computer readable storage medium is disclosed. The medium may have data stored therein representing an executable by a computer, the software may include instructions to perform steps of obtaining data for processing training, and taking the obtained data for processing training and making a dictionary from the obtained data. The method may further comprise training a machine learning algorithm with the dictionary. The method may further comprise obtaining field data related to a geological environment and denoising the field data, wherein a machine learning is used to perform the denoising and determining a probability function of the denoised field data to determine a probability density function. The method may also comprise using the probability function to determine a presence of an event within the obtained data.

In another example embodiment, the medium may be configured wherein the method performed by the medium includes that the event is a microseismic event.

In another example embodiment, the medium may be configured wherein the method performed by the medium includes the field data is obtained from sensors on at least one fiber optic cable.

In another example embodiment, the medium may be configured wherein the method performed by the medium includes reducing a dimensionality of the denoised data.

In another example embodiment, the medium is configured to be non-transitory.

In another example embodiment, a method for processing microseismic waveform field data is disclosed. The method may comprise obtaining geological training data. The method may further comprise making a dictionary from the obtained geological training data. The method may further comprise training a machine learning algorithm with the dictionary. The method may further comprise obtaining the geological microseismic waveform field data. The method may further comprise denoising the geological microseismic waveform field data with the machine learning algorithm to produce denoised field data. The method may further comprise using the probability function to determine a presence of an event within the geological microseismic waveform field data.

In another example embodiment, the method may further comprise at least one of displaying and storing the probability function in a non-volatile memory system.

In another example embodiment, the method may be performed wherein the denoising is performed by a classifier.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for processing data, comprising:
obtaining data for processing training;
taking the obtained data for processing training and making a dictionary from the obtained data;
training a machine learning algorithm with the dictionary;
obtaining field data related to a geological environment;
denoising the field data, wherein the machine learning algorithm is used to perform the denoising;
determining a probability function of the denoised field data to determine a probability density function;
using the probability function to determine a presence of an event within the obtained data; and
at least one of displaying and storing the probability function in a non-volatile memory system.

2. The method according to claim 1, wherein the event is a microseismic event.

3. The method according to claim 1, wherein the field data is obtained from sensors on at least one fiber optic cable.

4. The method according to claim 1, further comprising:
reducing a dimensionality of the denoised data.

5. The method according to claim 1, wherein the denoising of the obtained data is performed by a classifier.

6. The method according to claim 5, wherein the classifier used a logistic regression to detect an event from a non-event.

7. The method according to claim 1, further comprising:
compressing time-series data after the denoising.

8. The method according to claim 1, wherein one of a decision tree, support vector machine, k-nearest neighbor, and neural network is used.

9. The method according to claim 1, wherein the method is performed in a downhole environment.

10. The method according to claim 9, further comprising:
transmitting the probability function to a surface environment.

11. The method according to claim 1, wherein the denoising of the field data removes data determined to be noise from the field data.

12. The method according to claim 1, further comprising compressing the denoised field data after the denoising the field data.

13. The method according to claim 12, further comprising transmitting the compressed field data.

14. A computer readable storage medium having data stored therein representing an executable by a computer, the software may include instructions to perform steps of:
obtaining data for processing training;
taking the obtained data for processing training and making a dictionary from the obtained data;
training a machine learning algorithm with the dictionary;
obtaining field data related to a geological environment
denoising the field data, wherein the machine learning algorithm is used to perform the denoising;
determining a probability function of the denoised field data to determine a probability density function; and
using the probability function to determine a presence of an event within the obtained data,

15. The computer readable storage medium of claim 14, wherein the method performed further embodies that the event is a microseismic event.

16. The computer readable storage medium of claim 14, wherein the field data is obtained from sensors on at least one fiber optic cable.

17. The computer readable storage medium of claim 14, wherein the method performed further comprises reducing a dimensionality of the denoised data.

18. The computer readable storage medium of claim 14, wherein the medium is non-transitory.

19. A method for processing microseismic waveform field data, comprising:
obtaining geological training data;
making a dictionary from the obtained geological training data;
training a machine learning algorithm with the dictionary;
obtaining the geological microseismic waveform field data;
denoising the geological microseismic waveform field data with the machine learning algorithm to produce denoised field data; and
using the probability function to determine a presence of an event within the geological microseismic waveform field data.

20. The method according to claim 19, further comprising at least one of displaying and storing the probability function in a non-volatile memory system.

21. The method according to claim 19, wherein the denoising is performed by a classifier.
